(19) United States
(12) Patent Application Publication
(10) Pub. No.: US 2010/0098812 A1
(43) Pub. Date: Apr. 22, 2010

(54) PRODUCT AND PROCESS FOR CREATING INSTANT FLAVORED ICED BEVERAGES

(76) Inventors: Yen Le, San Jose, CA (US); Chieu Le, San Jose, CA (US)

Correspondence Address: BUUS, KIM, KUO, & TRAN, APC, 4675 MacArthur Court, Suite 590, Newport Beach, CA, 92660, US

(21) Appl. No.: 12/254,701

(22) Filed: Oct. 20, 2008

(51) Int. Cl. A23F 5/00; B65D 85/72; B65B 55/00; B65D 81/34

(52) U.S. Cl. 426/106; 426/393; 426/383

(57) ABSTRACT

The present invention is a product and method for making an instant iced coffee beverage but may be used to create any type of flavored beverage product. The method of producing an instant iced coffee beverage product comprising of providing a mixture of crushed ice, uncrushed ice, and liquid coffee in a container; a freezing step to freeze the mixture allowing the mixture to freeze into solid phase before the crushed ice substantially melts into the coffee; a sealing step to seal an opening of the container and a storing step to store the container in the freezer at or below freezing point. The product is then thawed in a microwave within a selected time frame which results in a freshly made instant iced coffee beverage.

### BACKGROUND OF THE INVENTION

(1) Field of the Invention

The field of the invention relates to iced beverages, and more particularly to a product and process of creating an instant iced coffee beverage for consumption.

(2) Description of Related Art

It can be appreciated that iced coffee beverages have been around for many years and has become a favorite among many drinkers. Iced coffee, is a cold variant of the normally hot beverage coffee. There are several ways of preparing iced coffee. Ordinary hot-brewed coffee can be served cold, although this may result in a bitter-tasting product. Cold brewing relies on time, rather than heat, to transfer the coffee flavor to the water. In order to achieve this, ground coffee is soaked in water for hours and then filtered. This may be done in any container, such as a mason jar, although commercialized cold brewing systems also exist

In more recent times it has become common for coffee shops to offer ‘iced’ versions of their most popular coffee drinks. The iced latte and iced mocha are the two most common examples of this. A quick way of preparing such drinks is to make a small quantity of strong, hot espresso, dissolving the required sweetener/flavorings in the hot liquid and then pouring this directly into a cup of ice cold milk. This method is particularly common in busier coffee shops where rapid customer turnover is required. Variations of iced coffee blends and mixtures exist all over the world. One particular popular iced coffee drink version is a Vietnamese Iced Coffee or commonly known as “Ca Phe Sua Da” or “Café Sua Da.” Literally, ca phe sua da means “iced milk coffee”. Ca phe sua da can be made simply by mixing black coffee with about a quarter to a half as much sweetened condensed milk and then pouring it over ice. A substitute made by many Vietnamese immigrants in the Southern U.S., particularly in Louisiana is a dark French roast, often with chicory; otherwise an imported Vietnamese-grown and roasted coffee is used when it is available. The coffee is traditionally brewed with a small metal Vietnamese drip filter into a cup containing the condensed milk. The condensed milk and coffee are stirred together and then poured over the ice. The term “iced coffee” refers to any iced coffee beverage/drink, including ice blended drinks.

However, because of the quick melting nature of ice and ice-blended coffee drinks/beverages, for the customer to enjoy the above stated drinks, he/she must typically purchase such drinks directly from a store that offers such drinks and consume such drinks in a relatively short period of time after purchase. Thus, an improved method and product for creating instant iced coffee is needed in the industry to allow customers to enjoy such iced or iced blended coffee beverages in a more convenient and accessible way.

All referenced patents, applications and literatures are incorporated herein by reference to their entirety. Furthermore, where a definition or use of a term in a reference, which is incorporated by reference herein, is inconsistent or contrary to the definition of that term provided herein, the definition of that term provided herein applies and the definition of the term in the reference does not apply. The invention may seek to satisfy one or more of the above-mentioned desires. Although the present invention may obviate one or more of the above-mentioned desires, it should be understood that some aspects of the invention might not necessarily obviate them.

In these respects, the product and process of creating instant iced coffee according to the present invention substantially departs from the conventional concepts and designs of the prior art, and so doing provides a product and method of creating instant iced coffee that is not anticipated, rendered obvious, suggested or even implied by any of the prior art product and process of creating instant iced coffee or ice blended beverages, either alone or in combination thereof In addition, in some embodiments of the contemplated inventive subject matter, other beverages can be used. For example, the contemplated inventive subject matter can be used to make an assortment of other flavored iced beverages such as thai tea, iced tea, iced alcoholic beverages, sodas, fruit juices, and lemonades.

### BRIEF SUMMARY OF THE INVENTION

In view of the foregoing disadvantages inherent in the known types of iced coffee beverages and ice blended coffee beverages and means now present in the prior art, the general purpose of the present invention, which will be described subsequently in greater detail, is to provide a product and method of creating instant iced coffee.

Another object of the present invention is to provide an instant iced coffee product that is contained in a sealed container;

Another object of the present invention is to provide a method to make instant iced coffee product that allows the instant iced coffee product to be consumed at a later time after the time of purchase;

Another object of the present invention is to provide an instant iced coffee product that is portable and convenient to drink;

Another object of the present invention is to provide a method of making instant iced coffee that preserves the right mixture of ice and coffee portions;

Another object of the present invention is to provide a marketing method of microwaving the iced coffee beverage to make the instant iced coffee product;

Another object of the present invention is to provide a method of making an instant iced coffee beverage that involves microwaving the iced coffee beverage at a pre-determined length of time which results in a fresh iced coffee beverage product;

Another object of the present invention is to provide a instant iced coffee product that involves microwaving the iced coffee beverage to produce a fresh iced beverage product;

Another object of the present invention is to provide the use of both crushed and uncrushed iced which allows for different degrees of thawing which provides the taste and feel of a freshly made iced beverage.

To attain this, the present invention in one embodiment generally comprises of a sealed container, a first portion of frozen water in solid phase disposed in the container, a second portion of frozen flavored beverage in solid phase disposed in the container. The ratio of the first portion to the second portion is 2 to 1 and the second portion of frozen flavored beverage has a weight of about 4 ounce to 10 ounce. The beverage product, wherein the flavored beverage is coffee and where the first portion of ice included uncrushed and crushed ice. The first portion of frozen water is solid phase is suspended within the second portion of frozen flavored beverage such that the first portion is not substantially dissolved into the second portion.

The method of producing an instant iced coffee beverage product comprising of providing a mixture of crushed ice, uncrushed ice, and liquid coffee in a container; a freezing step to freeze the mixture allowing the mixture to freeze into solid phase before the crushed ice substantially melts into the coffee; a sealing step to seal an opening of the container and a storing step to store the container in the freezer at or below freezing point. The freezing step is a flash freeze step to freeze the mixture to solid phase within 120 second at a temperature colder than −15 degrees Celsius. The mixture ratio is two parts ice and one part liquid coffee. In one embodiment of the contemplated inventive subject matter, the method of producing an instant iced coffee beverage product results in the coffee having a weight of about 4 to 10 ounces and which is typically contained in a 16 ounce PET cup.

The contemplated inventive subject matter also involves a marketing method comprising of indication in writing that the product is a microwaveable instant iced beverage which is to be thawed in a microwave by a consumer for no more than 120 seconds before consumption which results in the production of a fresh iced beverage product. The marketing method also includes selling the beverage product in a solid phase which contains a mixture of crushed ice, uncrushed ice, and a frozen flavored beverage in solid phase. The marketing method further indicating in writing that the existence of crushed ice and uncrushed ice allows different degrees of thawing and provides the taste and feel of a freshly made iced beverage. The marketing method in writing providing a best mode time range of between 50-100 seconds of microwave usage to provide the ideal consistency between the crushed ice, uncrushed ice and coffee or flavored beverage mixture.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of the construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting. To accomplish the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWING(S)

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a perspective view of the instant iced beverage product in its solid phase as contemplated b the inventive subject matter;

FIG. 2 is a diagram depicting the method steps of the contemplated inventive subject matter to produce an instant iced beverage product;

FIG. 3 is a diagram depicting another possible sequence of the method steps of the contemplated inventive subject matter to produce an instant iced beverage product;

FIG. 4 is a diagram depicting the marketing method to produce an instant iced beverage product as contemplated by the inventive subject matter.

### DETAILED DESCRIPTION OF THE INVENTION

The invention and its various embodiments can now be better understood by turning to the following detailed description of the preferred embodiments, which are presented as illustrated examples of the invention defined in the claims. It is expressly understood that the invention as defined by the claims may be broader than the illustrated embodiments described below.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claims are set forth below in a certain combination, it must be expressly understood that the invention includes other combinations of fewer, more or different elements, which are disclosed herein even when not initially claimed in such combinations.

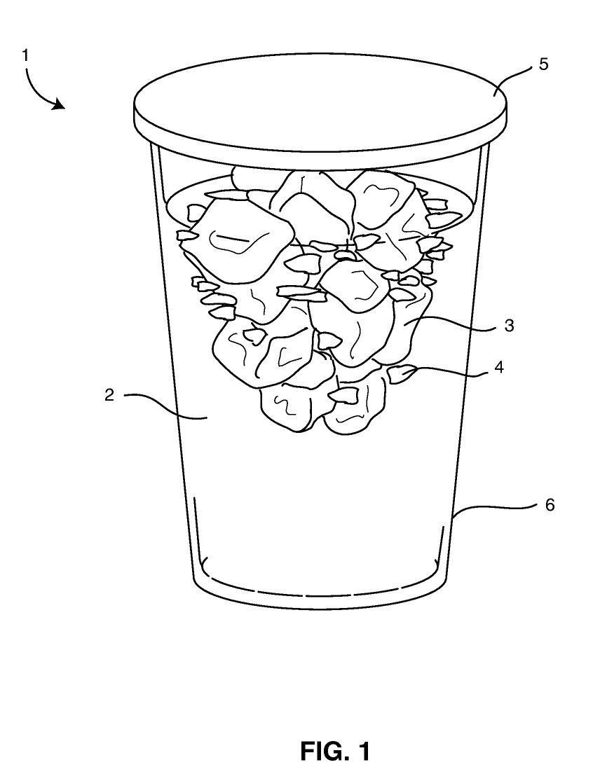

Referring now to the drawings, which are provided by way of illustration and example, and wherein like reference numerals designate like or corresponding elements among the several views, there is shown in FIG. 1, an instant iced coffee beverage 1, shown in its solid phase form containing a second portion of flavored beverage in solid phase form 2, first portions of water in solid phase form comprising of uncrushed ice 3 and crushed ice 4, containing a lid 5 covering a PET cup 6. In one present embodiment, the flavored beverage 2 is coffee and the mixture ration of ice (uncrushed ice 3 and crushed ice 4 combined) to liquid coffee can be either 2:1, 1:1 or 1:2 depending on the taste preference and/or strength of the desired coffee. In typical use, the consumer would purchase the instant iced beverage as contemplated by the inventive subject matter and then store it in a regular freezer until consumption is later desired. Once consumption is desired, the consumer would merely microwave the instant iced beverage product according to the provided instructions whereby resulting in a freshly made iced coffee beverage product.

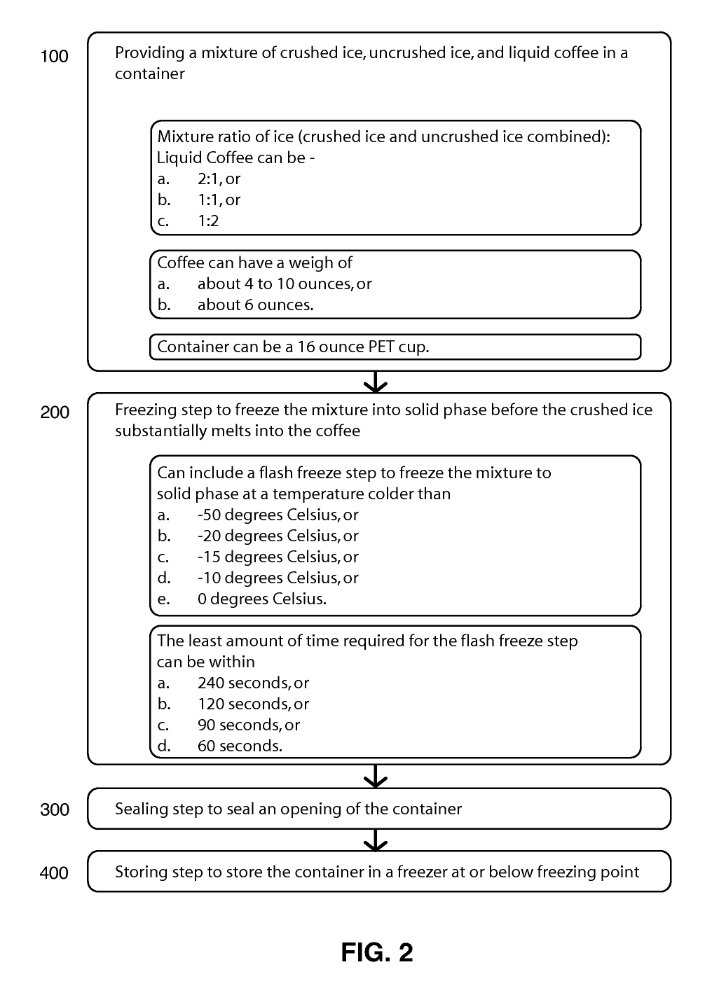

Turning to FIG. 2, the method steps of producing an instant iced coffee beverage are described. As seen, the first step 100 is to provide a mixture of crushed ice 4, uncrushed ice 3 and liquid coffee 2 where the mixture of ration of ice to liquid coffee can be either 2:1, 1:1 or 1:2. The coffee can have a weight of about 4 to 10 ounces or about 6 ounces. The container 6 can be a typical 16 ounce PET cup. The freezing step 200 freezes the mixture into a solid phase before the crushed ice 4 substantially melts into the coffee. The freezing step to freeze the mixture to solid phase can be at a temperature colder than

(a) −50 degrees Celsius or

(b) −20 degrees Celsius or

(c) −15 degrees Celsius or

(d) −10 degrees Celsius or

(e) 0 degrees Celsius.

In addition, the lease amount of time required for the flash freeze step to occur can be within

(a) 240 seconds, or

(b) 120 seconds or

(c) 90 seconds or

(d) 60 seconds.

The next step 300 defines the sealing step necessary to seal the lid to the container 6. Lastly, the container comprising of the instant iced coffee beverage product is stored 400 in a freezer at or below freezing point to keep the contents of the instant iced coffee beverage in a solid phase.

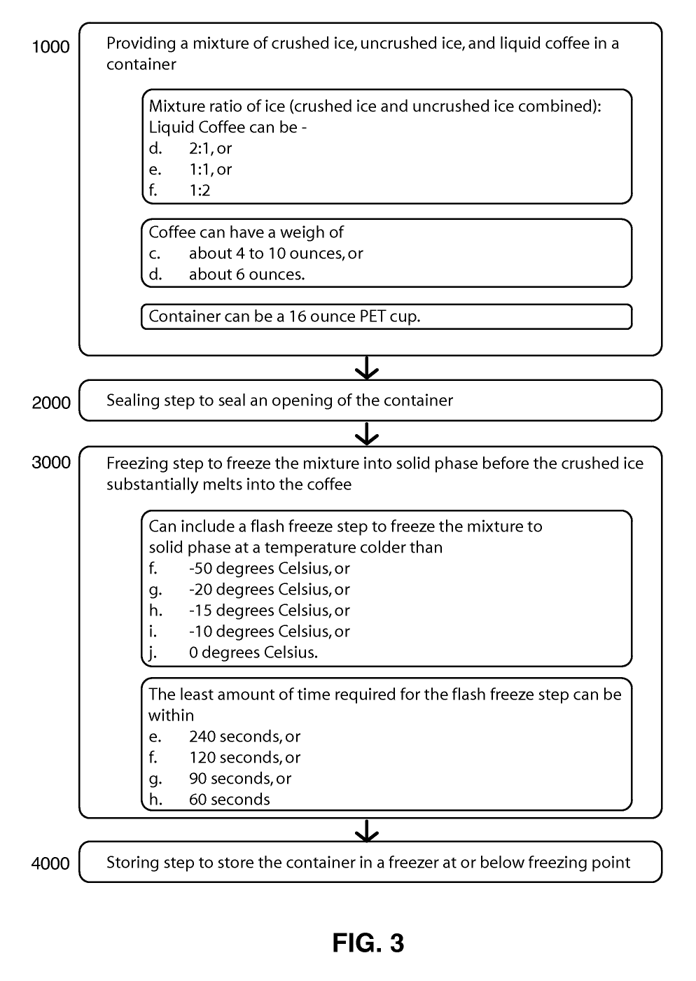

FIG. 3 provides another possible embodiment of the method steps in producing an instant iced coffee beverage product as contemplated by the inventive subject matter in which the first step 1000 is to provide a mixture of crushed ice 4, uncrushed ice 3 and liquid coffee 2 in a container. The mixture ration of ice to liquid coffee being either 2:1, 1:1 or 1:2a and the coffee having a weight of about 4 to 10 ounces or about 6 ounces. The container 6 being a 16 ounce PET cup. The next step would sealing step 2000 including sealing the opening of the container 6 with a lid 5. Immediately following the sealing step would be the freezing step 3000 which freezes the mixture into a solid phase before the crushed ice 4 substantially melts into the coffee. The freezing step 3000 can consist of flash freezing the mixture into a solid phase at a temperature colder than the above stated temperatures and time periods as outlined in FIG. 2, step 200. Last step 4000 provides for the storage of the container 6 in a freezer at or below freezing point.

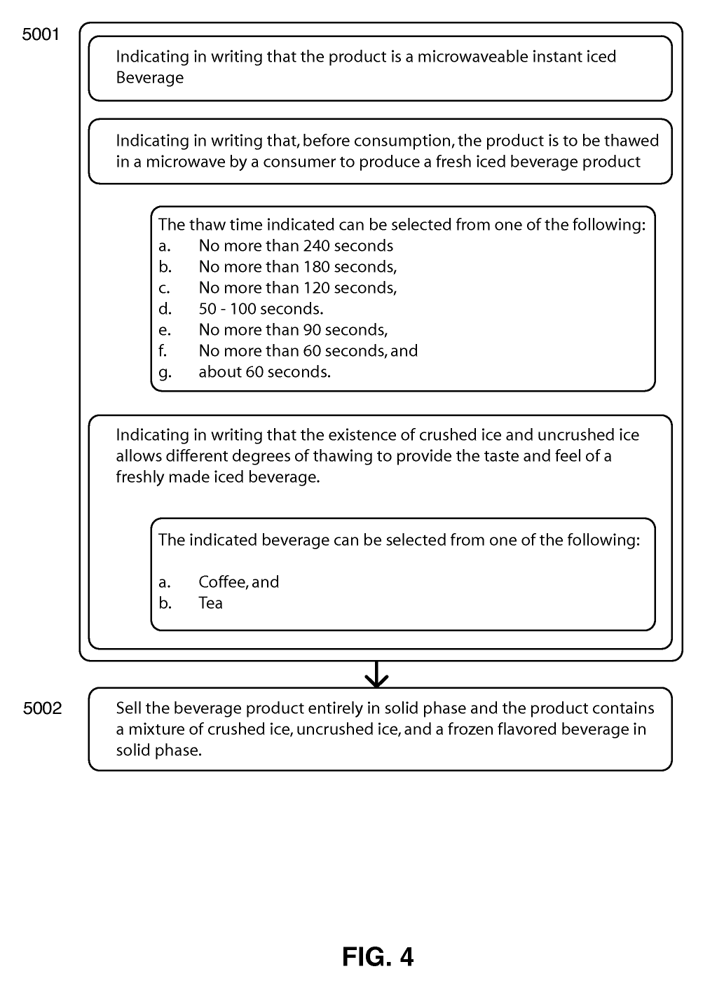

Turning to FIG. 4, a marketing method is provided in writing 5001 to produce a microwaveable instant iced coffee beverage. The marketing method in writing explains how before consumption, the product is to be thawed in a microwave for a certain period of time to produce the fresh instant iced coffee beverage. The period of time being selected from one of the following:

(a) No more than 240 seconds;

(b) No more than 180 seconds;

(c) No more than 120 seconds;

(d) 50-100 seconds;

(e) No more than 90 seconds;

(f) No more than 60 seconds;

(g) about 60 seconds.

The marketing method, further providing in writing that the existence of crushed ice and uncrushed ice allows for different degrees of thawing to provide the taste and feel of a freshly made iced beverage. In one embodiment, the indicated beverage is selected from either coffee and/or tea.

The marketing method further provides for a sales step 5002 in which the beverage product as contemplated by the inventive subject matter is sold entirely in solid phase and the product containing a mixture of crushed ice, uncrushed ice, and a frozen beverage in solid phase.

Thus, specific embodiments and applications of the product and method to produce an instant iced coffee beverage have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

What is claimed is:

1. A beverage product comprising:
a sealed container;
a first portion of frozen water in solid phase disposed in the container; and
a second portion of frozen flavored beverage in solid phase disposed in the container.

2. The beverage product as recited in claim 1, wherein the sealed container is a PET plastic cup.

3. The beverage product as recited in claim 2, wherein the ratio of the first portion to second portion is 2:1.

4. The beverage product as recited in claim 3, wherein the second portion of frozen flavored beverage has a weight of about 4 ounce to 10 ounce.

5. The beverage product as recited in claim 4, wherein the weight of the second portion of frozen flavored beverage is 6 ounce.

6. The beverage product as recited in claim 3, wherein the flavored beverage is coffee, and wherein the first portion of ice includes uncrushed ice and crushed ice.

7. The beverage product as recited in claim 6, wherein the first portion of frozen water in solid phase is suspended within the second portion of frozen flavored beverage such that the first portion is not substantially dissolved into the second portion.

8. A method of producing an instant ice coffee beverage product, the method comprising:
providing a mixture of crushed ice, uncrushed ice, and liquid coffee in a container;
a freezing step to freeze the mixture allowing the mixture to freeze into solid phase before the crushed ice substantially melts into the coffee;
sealing step to seal an opening of the container;
storing step to store the container in the freezer at or below freezing point.

9. The method of producing an instant ice coffee beverage product as recited in claim 8, wherein the freezing step is a flash freeze step to freeze the mixture to solid phase within 120 second at a temperature colder than −15 degrees Celsius.

10. The method of producing an instant ice coffee beverage product as recited in claim 9, wherein the mixture is a ratio of two parts ice and one part liquid coffee.

11. The method of producing an instant ice coffee beverage product as recited in claim 10, wherein the coffee has a weight of about 4 to 10 ounces.

12. The method of producing an instant ice coffee beverage product as recited in claim 10, wherein the coffee has a weight of about 6 ounces, and the container is a 16 ounce PET cup.

13. A marketing method for an iced beverage product comprising:
indicating in writing that the product is a microwaveable instant iced beverage;
indicating in writing that the product is to be thawed in a microwave by a consumer for a thaw time no more than 120 seconds before consumption to produce a fresh iced beverage product; and wherein the beverage product is sold entirely in solid phase and contains a mixture of crushed ice, uncrushed ice, and a frozen flavored beverage in solid phase.

14. The marketing method as recited in claim 13 further indicating in writing that the thaw time is 50-100 seconds.

15. The marketing method as recited in claim 14, wherein the thaw time is about 60 seconds.

16. The marketing method as recited in claim 15 further indicating in writing that the existence of crushed ice and uncrushed ice allows different degrees of thawing and provides the taste and feel of a freshly made iced beverage.

17. The marketing method as recited in claim 16, wherein the flavored beverage is coffee.
